(19) United States
(12) Patent Application Publication
(10) Pub. No.: US 2016/0224087 A1
(43) Pub. Date: Aug. 4, 2016

(54) OVER-CURRENT DETECTION CIRCUIT AND OVER-CURRENT DETECTION SYSTEM WITH OVER-CURRENT DETECTION CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JIE MIN, Wuhan (CN); CHUN-SHENG CHEN, New Taipei (TW)

(21) Appl. No.: 14/685,209

(22) Filed: Apr. 13, 2015

(30) Foreign Application Priority Data
Jan. 31, 2015 (CN) 201510049401.0

(51) Int. Cl. G06F 1/30; G06F 1/28; H02H 3/08

(52) U.S. Cl. CPC G06F 1/30; H02H 3/08; G06F 1/28

(57) ABSTRACT

An over-current detection circuit includes a power supply module, a control circuit, and a control chip. The control circuit includes a first switch and a second switch. The power supply module is configured to not supply power to an interface when over-current is present at the interface. The control chip is configured to output a control signal when detecting over-current is present at the interface. The first switch is configured to be switched off after receiving the control signal. The second switch is configured to be switched on after the first switch is switched off. The control chip is configured to output a detection signal after the second switch is switched on. An over-current detection system is also provided.

### CROSS-REFERENCE TO RELATED APPLICATIONS

This application claims priority to Chinese Patent Application No. 201510049401.0 Jan. 31, 2015, the contents of which are incorporated by reference herein.

### FIELD

The subject matter herein generally relates to detection systems.

### BACKGROUND

An over-current detection system may be used to detect whether an over-current is present at an interface.

### BRIEF DESCRIPTION OF THE DRAWINGS

Implementations of the present technology will now be described, by way of example only, with reference to the attached figures.

FIG. 1 is a block diagram of one embodiment of an over-current detection system and an interface.

FIG. 2 is a circuit diagram of a detection circuit of the over-current detection system and the interface of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to an over-current detection system may be used to detect whether an over-current is at a USB interface.

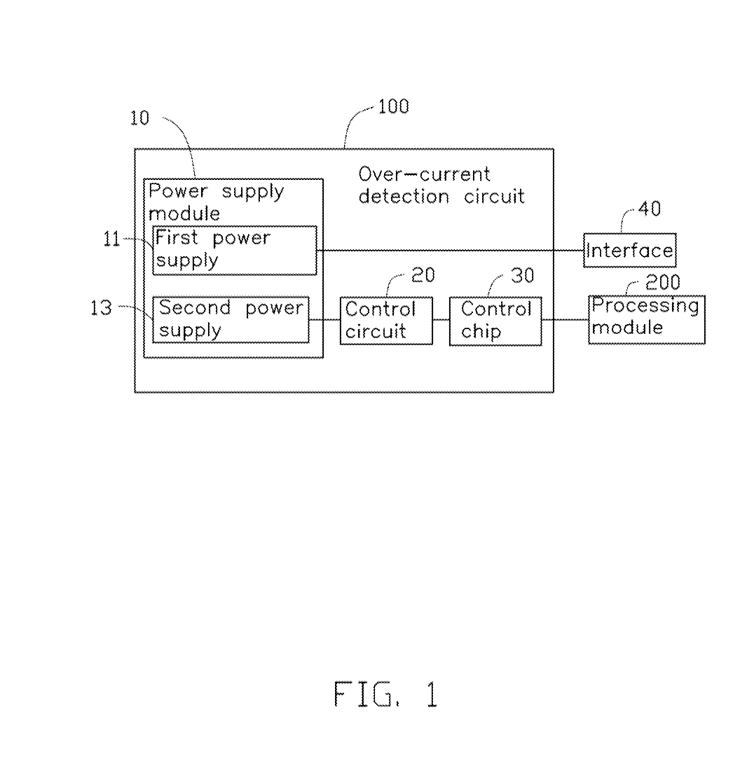

FIG. 1 illustrates an embodiment of an over-current detection system. The over-current detection system is used in a computer. The over-current detection system comprises an over-current detection circuit 100 and a processing module 200. The over-current detection circuit 100 comprises a power supply module 10, a control circuit 20, and a control chip 30. The control chip 30 is coupled to the processing module 200.

The power supply module 10 comprises a first power supply 11 and a second power supply 13. The first power supply 11 is configured to supply power to an interface 40 via a fuse F1. In one embodiment, the first power supply 11 is configured to provide a 5V voltage, the second power supply 13 is configured to provide a 3V voltage, the fuse F1 is a recoverable fuse, and the interface 40 is a USB interface.

The control circuit 20 comprises a first switch Q1 and a second switch Q2. Each of the first switch Q1 and the second switch Q2 comprises a control terminal G, a first connecting terminal S, and a second connecting terminal D. In one embodiment, each of the first switch Q1 and the second switch Q2 is an n-channel field effect transistor (FET).

The control chip 30 comprises a control pin GPIO and a detection pin OC. The control pin GPIO of the control chip 30 is configured to output a control signal. The detection pin OC of the control chip 30 is configured to output a detection signal.

In one embodiment, the control chip 30 is a north bridge chip (PCH).

The control chip 30 is configured to output a low level detection signal after detecting an over-current is present at the interface 40. The processing module 200 is configured to record error information after receiving the low level detection signal. The processing module 200 outputs error information when the computer is in Windows mode. If the computer is in DOS mode or a sleep mode, the processing module 200 will output error information after the computer is in Windows mode next time.

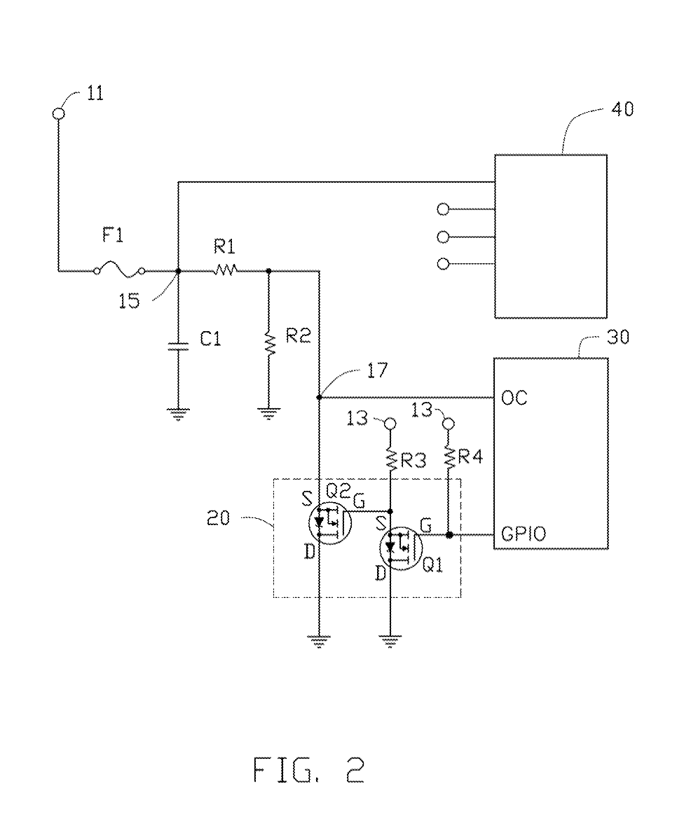

FIG. 2 illustrates that the first power supply 11 is coupled to a first node 15 via the fuse F1. The first node 15 is grounded via a capacitor C1. The first node 15 is coupled to the interface 40. The first node 15 is coupled to a second node 17 via a first resistor R1. The second node 17 is grounded via a second resistor R2. The second node 17 is coupled to the first connecting terminal S of the second switch Q2. The second node 17 is coupled to the detection pin OC of the control chip 30. The second connecting terminal D of the second switch Q2 is grounded. The control terminal G of the second switch Q2 is coupled to the first connecting terminal S of the first switch Q1. The control terminal G of the second switch Q2 is coupled to the second power supply 13 via a third resistor R3. The second connecting terminal D of the first switch Q1 is grounded. The control terminal G of the first switch Q1 is coupled to the control pin GPIO of the control chip 30. The control pin GPIO of the control chip 30 is coupled to the second power supply 13 via a fourth resistor R4.

A working principle of the over-current detection system is as follows. When an over-current is present at the interface 40, the fuse F1 is switched off. The interface 40 is disconnected from the control chip 30. The first power supply 11 does not supply power to the interface 40. The control chip 30 outputs a low level detection signal. If the computer is in the Windows mode, the processing module 200 outputs error information after receiving the low level detection signal. If the computer is in the DOS mode or sleep mode, the processing module 200 records error information after receiving the low level detection signal. The control chip 30 outputs a low level control signal after the computer is in the Windows mode next time. The first switch Q1 is switched off after receiving the low level control signal. The second switch Q2 is switched on after the first switch Q1 is switched off. The control chip 30 outputs a low level detection signal after the second switch Q2 is switched on. The processing module 200 outputs the error information after receiving the low level detection signal.

When the interface 40 is in a normal state, the control chip 30 outputs a high level control signal. The first switch Q1 is switched on after receiving the high level control signal. The second switch Q2 is switched off after the first switch Q1 is switched on. The control chip 30 outputs a high level detection signal after the second switch Q2 is switched off. The processing module 200 does not output the error information.

In one embodiment, each control terminal G is a gate terminal, each first connecting terminal S is a source terminal, and each second connecting terminal D is a drain terminal.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An over-current detection circuit comprising:
a power supply module connected to an interface;
a control chip; and
a control circuit having:
a first switch coupled to the control chip; and
a second switch coupled to the first switch;
wherein, the power supply is configured to not supply power to the interface when an over-current is present at the interface;
wherein, the control chip is configured to output a control signal to the first switch when an over-current is detected at the interface;
wherein, the first switch switches off when the control signal is received from the control chip;
wherein, the second switch is switched on when the first switch is switched off; and
wherein, an over currant detection signal is outputted from the control switch when the second switch is switched off.

2. The detection circuit of claim 1, wherein the control chip comprises a control pin, the first switch is coupled to the control pin of the control chip, and the control pin is configured to output the control signal.

3. The detection circuit of claim 2, wherein the control chip further comprises a detection pin, the second switch is coupled to the detection pin of the control chip, and the detection pin is configured to output the detection signal.

4. The detection circuit of claim 3, wherein the first switch comprises a control terminal and a connecting terminal, the control terminal of the first switch is coupled to the control pin of the control chip, and the connecting terminal of the first switch is coupled to the second switch.

5. The detection circuit of claim 4, wherein the second switch comprises a control terminal and a connecting terminal, the connecting terminal of the first switch is coupled to the control terminal of the second switch, and the connecting terminal of the second switch is coupled to the detection pin of the control chip.

6. The detection circuit of claim 5, wherein each of first switch and the second switch is an n-channel field effect transistor (FET).

7. The detection circuit of claim 6, wherein each control terminal of the first switch and the second switch is a gate terminal, and each connecting terminal of the first switch and the second switch is a source terminal.

8. The detection circuit of claim 1, wherein the control signal is a low level signal.

9. The detection circuit of claim 1, wherein the detection signal is a low level signal.

10. The detection circuit of claim 1, wherein the power supply module comprises a power supply, the power supply is configured to couple to the interface via a fuse, the power supply is coupled to the control chip and the control circuit via the fuse, the fuse is configured to be switched off when the over-current is present at the interface, and the power supply is configured to not supply power to the interface upon the fuse is switched off.

11. An over-current detection circuit used in a computer and comprising:
a power supply module connected to an interface;
a control chip; and
a control circuit having:
a first switch coupled to the control chip; and
a second switch coupled to the power supply module and the first switch;
wherein the computer includes a processing module;
wherein, the power supply is configured to not supply power to the interface when an over-current is present at the interface;
wherein, the control chip is configured to output a control signal to the first switch when an over-current is present at the interface;
wherein, the first switch switches off when the control signal is received from the control chip;
wherein, the second switch is switched on when the first switch is switched off; and
wherein, an over currant detection signal is outputted from the control switch when the second switch is switched off;
wherein the control chip is further configured to output a detection signal after the second switch is switched on; and
wherein the processing module is configured to output error information after receiving the detection signal.

12. The detection circuit of claim 11, wherein the control chip comprises a control pin and a detection pin, the first switch is coupled to the control pin of the control chip, the second switch is coupled to the detection pin of the control chip, the control pin is configured to output the control signal, and the detection pin is configured to output the detection signal.

13. The detection circuit of claim 12, wherein each of the first switch and the second switch comprises a control terminal and a connecting terminal, the control terminal of the first switch is coupled to the control pin of the control chip, the connecting terminal of the first switch is coupled to the control terminal of the second switch, and the connecting terminal of the second switch is coupled to the detection pin of the control chip.

14. The detection circuit of claim 13, wherein each of first switch and the second switch is an n-channel field effect transistor (FET).

15. The detection circuit of claim 14, wherein each control terminal of the first switch and the second switch is a gate terminal, and each connecting terminal of the first switch and the second switch is a source terminal.

16. The detection circuit of claim 11, wherein the control signal is a low level signal.

17. The detection circuit of claim 11, wherein the detection signal is a low level signal.

18. The detection circuit of claim 11, wherein the power supply module comprises a power supply, the power supply is configured to couple to the interface via a fuse, the power supply is coupled to the control chip and the control circuit via the fuse, the fuse is configured to be switched off when the over-current is present at the interface, and the power supply is configured to not supply power to the interface upon the fuse is switched off.

19. An over-current detection system comprising:
an over-current detection circuit comprising:
a power supply module configured to supply power to an interface;
a control chip coupled to the power supply module; and
a control circuit having a first switch and a second switch; and
a processing module;
wherein the first switch is coupled to the control chip;
wherein the second switch is coupled to the power supply module and the first switch;
wherein the power supply module is configured to not supply power to the interface when an over-current is present at the interface;
wherein the control chip is configured to output a control signal when detecting the over-current is present at the interface;
wherein the first switch switches off when the control signal is received from the control chip;
wherein the second switch is switched on when the first switch is switched off;
wherein the control chip is configured to output a detection signal after the second switch is switched on; and
wherein the processing module is configured to output error information after receiving the detection signal.

20. The over-current detection system of claim 19, wherein the control signal is a low level signal.
